(19) United States
(12) Patent Application Publication
(10) Pub. No.: US 2016/0023625 A1
(43) Pub. Date: Jan. 28, 2016

(54) AIRBAG COVER HINGE WITH PRESSURE-SENSING SYSTEM

(71) Applicant: K.L. KASCHIER- UND LAMINIER GMBH, Bed Bentheim-Gildehaus (DE)

(72) Inventor: Albert RORING, Bad Bentheim-Gildehaus (DE)

(21) Appl. No.: 14/782,384

(22) PCT Filed: Feb. 13, 2015
(86) PCT No.: PCT/EP2015/000316

§ 371 Date: Oct. 5, 2015

(30) Foreign Application Priority Data
Mar. 20, 2013 (DE) 10 2014 003 972.2

(51) Int. Cl. B60R 21/215

(52) U.S. Cl. CPC B60R 21/215; B60R 2021/21537

(57) ABSTRACT

The invention relates to an airbag cover hinge comprising a textile hinge, which can be connected to the airbag cover as well as to a supporting part surrounding the airbag cover, wherein the airbag cover hinge has a textile base structure, in which stop threads are integrated, the tensile strength of which is the same as or lower than of the threads of the base structure and the length of which is greater than the textile base structure.

The innovation relates to an airbag cover hinge having a textile hinge that is connectable both to the airbag cover as well as a support part surrounding the airbag cover.

When the airbag is triggered, the airbag cover opens in order to enable the deployment of the airbag, and the airbag cover hinge enables guiding of the airbag cover when being opened.

An airbag hinge of woven fabric or warp-knitted fabric is known. Depending on the size of the airbag cover employed, various forces act on the hinge of the airbag cover when the airbag is triggered. The larger the airbag cover or the heavier an airbag cover, respectively, the greater the forces that act on the hinge, and it has to be ensured, on the one hand, that the airbag cover readily opens when the airbag is triggered, and on the other hand, it is to be ensured that the airbag cover is not released under any circumstances from the support part by which it is surrounded, so as not to endanger persons in the region of the airbag.

In the hinge of an airbag cover that is known from the prior art, rupturing of the hinge that is implemented as a woven fabric or a warp-knitted fabric cannot be excluded under unfavorable conditions.

The innovation is thus based on the object of configuring a hinge for an airbag cover in such a manner that rupturing or releasing, respectively, of the hinge for the airbag cover can be reliably prevented and, moreover, easy opening of the airbag cover is enabled at cost-effective manufacturability.

The object on which the innovation is based is achieved by the teachings of the characterizing part of the main claim.

In other words, a hinge for an airbag cover that has a multi-stage main textile structure in which stop filaments that have a tensile strength that is the same as or lower than the main textile structure and also have longer travel than the main textile structure, are integrated as load-bearing filaments, is proposed.

Using this configuration, two systems are integrated, that is to say one system that ruptures when a defined tensile load is exceeded, so as to in this manner bear a major part of the arising tensile load, and a second system that implements opening of the airbag cover (opening angle) in a defined manner while providing a secure mounting.

Advantageous design embodiments are explained in the dependent claims.

Advantageously, the main structure is configured as a warp-knitted fabric or a woven fabric, so as to achieve both a cost-effective configuration of the main structure as well as optimal handling.

In one advantageous embodiment, the “stop filaments” (load filaments) are oriented in the direction of the tensile load of the hinge, wherein a regular distribution of the stop filaments across the main textile structure is advantageous, so as to obtain at all times an adequate number of stop filaments in the main textile structure when the hinges are punched from a comparatively large piece of material, for example.

One potential configuration includes the regular sequence of in each case two filler filaments of the main textile structure and one stop filament (load-bearing filament), wherein this sequence may however be adapted according to the respective conditions.

In one advantageous design embodiment, the main textile structure relative to the stop filaments (load-bearing filaments) is configured such that initially rupturing of the main structure takes place.

Relative to the filaments of the main textile structure, the stop filaments have a greater length and in their longitudinal profile are for example configured so as to be meandering, zigzag-shaped, loop-shaped, curved, undulated and/or self-covering, such that the stop filaments have a reserve region that is configured so as to be substantially transverse and/or longitudinal relative to the direction of traction.

Preferably, a greater length of the stop filaments is achieved in that the stop filaments form loops that at least in part project in a perpendicular and/or oblique manner from the surface of the main textile structure, or are inlaid in a flat manner in the main structure.

The proposed multi-stage structure that is composed of a main textile structure and stop filaments (load-bearing filaments) in turn may again be embedded in a two-dimensional textile structure, such that, in the event of tensile loading of the cover hinge, rupturing or opening of the main textile structure including the stop filaments (load-bearing filaments) out of this two-dimensional textile structure takes place, so as to dissipate at least to some degree forces that have already arisen on account of this rupturing or opening operation, and to simultaneously define the travel for opening (opening angle) of the airbag lid. Illustrated embodiments of the innovation are illustrated in the drawings, in which:

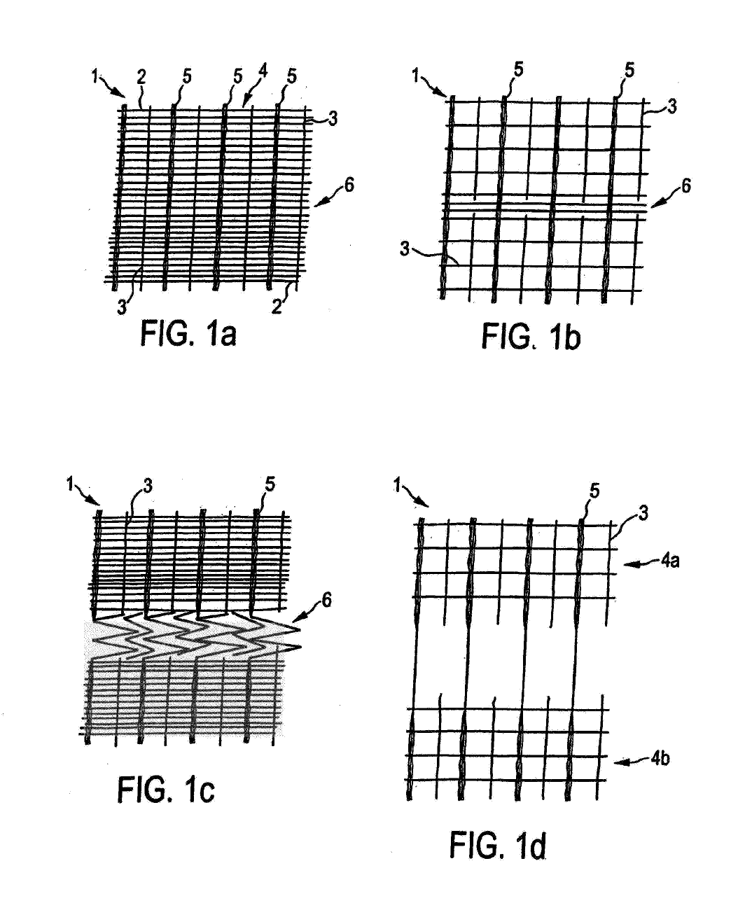

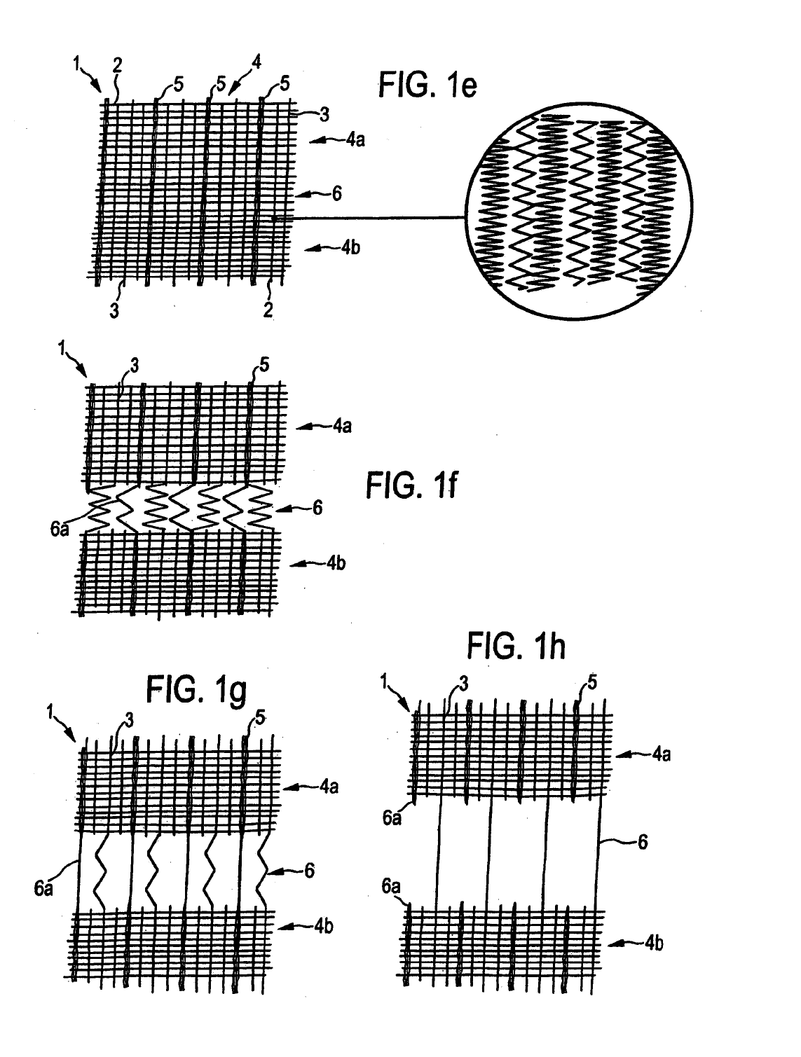

FIGS. 1a-1d show an illustrated embodiment of the innovation in various stages of tensile loading on the hinge;

FIGS. 1e-1h show a further illustrated embodiment in various stages of tensile loading on the hinge;

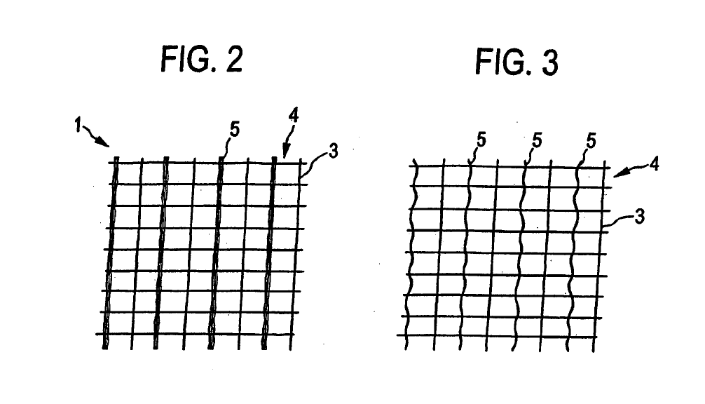

FIGS. 2 and 3 show further embodiments.

With reference to FIGS. 1a-1d, an airbag cover hinge referred to as 1 that is composed of filaments 2 and 3 of a main textile structure 4, is illustrated, wherein this main textile is structure in this illustrated embodiment is configured as a warp-knitted fabric or a woven fabric.

So-called stop filaments 5 that have a tensile strength that is the same as or lower than the filaments of the main structure and that are also composed of polyester or other suitable materials, are integrated in this main textile structure.

The stop filaments 5 are oriented in the direction of a tensile load that acts on the hinge of the airbag cover when the airbag cover is opened and have at least one reserve region 6 in which the stop filaments are stored in a manner that is substantially transverse to the tensile load.

On account of integrated filament deposition (travel reserve), reserve regions (across the entire area, FIG. 1a, or part-regions, FIG. 1b) enable a force to be borne by way of the strength of the filaments, and also defined opening of the airbag lid by way of the possible travel.

Once the airbag has been triggered, the airbag cover that covers the airbag opens and the main textile structure 4 that is incorporated in the region of the airbag cover hinge is elongated to the point of rupture when the hinge is opened. The process of loading the hinge is schematically illustrated in FIGS. 1c and 1d. The main textile structure is thus initially elongated in the region of the reserve region 6, in that the high-strength stop filaments 5 permit this elongation of the main textile structure up to the point of rupture (load bearing).

In the illustrated embodiment of FIG. 1c, the reserve region of the stop filaments 5 by meandering or depositing in a zigzag-shape is schematically illustrated for example.

FIG. 1d in an exemplary manner shows the travel of the stop filaments that can be made available when the airbag cover is opened, while load is simultaneously being borne by the stop filaments.

Depending on the number of stop filaments, or depending on the specification of the tensile strength of these stop filaments 5, respectively, the total strength of the airbag cover hinge 1 is determined.

In one textile embodiment, in each case two (filler) filaments 3 of the main textile structure 4 may be present and adjoin one stop filament 5, such that a sequence of two filaments 3 of the main textile structure 4 and of one stop filament 5 is provided across the width of the airbag cover hinge 1. However, it is to be understood that, depending on the desired tensile strength, the specific configurations may be adapted according to the respective conditions.

With reference to FIG. 1c, in the event of the airbag cover being further opened (multi-stage), the situation of the airbag cover hinge 1 is illustrated, in which the filaments 3 of the main textile structure 4 have ruptured on account of tensile loading (elongation) and in which the stop filaments 5 running in a transverse and/or longitudinal manner in the reserve region 6 are oriented so as to correspond to the tensile load.

In the event of further tensile loading on account of the airbag cover being opened wider, the situation according to FIG. 1d arises, in which the load-bearing stop filaments 5 hold both of the is now ruptured part-regions 4a and 4b of the main textile structure. On account of the high-strength configuration of the stop filaments 5, rupturing of the entire airbag cover hinge 1 is reliably prevented. The filament reserve allows the required travel for the airbag cover to be opened and simultaneously precludes the airbag cover being undesirably torn off.

The maximum region of extension of the airbag cover hinge 1, that is to say the spacing of the part-regions 4a and 4b of the main structure 4, is defined by the length of the stop filaments 5 that run in a transverse manner in the reserve region 6. The number and the tensile strength of the stop filaments 5 has to be conceived such that the latter bear the residual load once the elongated main textile structure 4 has ruptured (multi-stage capability).

FIGS. 1f and 1g show that the stop filaments relative to one another may have variable lengths and/or variable tensile strengths, so as to implement a dual-stage or multi-stage load bearing during opening.

In one further embodiment according to FIG. 2, the stop filaments 5 are configured so as to substantially correspond to the tensile load of the airbag cover hinge 1, wherein the stop filaments 5 have a certain elasticity and enable elongation and, on account thereof, load bearing by way of the main textile structure 4.

After the filaments 3 of the main textile structure 4 have ruptured, coherence of the ruptured regions 4a and 4b of the main textile structure is ensured, or complete disintegration of the airbag cover hinge 1 is prevented, respectively.

In the further embodiments according to FIGS. 3 and 4, the stop filaments 5 are inlaid in the main textile structure 4 in a meandering or zigzag manner, respectively, and this results in a “reserve region” that is configured across the entire length of the stop filaments 5, such that the stop filaments enable elongating and subsequent rupturing of the filaments 3 of the main textile structure 4, and subsequently prevent complete disintegration of the regions 4a and 4b of the main textile structure 4.

In FIG. 4 the meandering or zigzag-shaped stop filaments/load-bearing filaments, respectively, are inlaid in the reserve region such that the reserve travel paths and the strengths define load bearing in the rotation axis of the airbag lid and enable the opening angle of the airbag lid and subsequently prevent complete disintegration of the regions 4a and 4b of the main textile structure.

Particularly simple lengthening of the stop filaments is achieved in that the stop filaments form loops that at least in part project in a perpendicular and/or oblique manner from the surface of the main textile structure, or are inlaid in a flat manner in the main structure.

1. An airbag cover hinge having a textile hinge that is connectable both to the airbag cover as well as a support part surrounding the airbag cover, wherein the airbag cover hinge has a main textile structure in which are integrated stop filaments that have a tensile strength that is the same as or lower than the filaments of the main structure and that relative to the main textile structure have a greater length.

2. The airbag cover hinge as defined in claim 1, wherein the main textile structure is a woven or a warp-knitted fabric.

3. The airbag cover hinge defined in claim 1, wherein the stop filaments are oriented in the direction of the a tensile load of the airbag cover hinge.

4. The airbag cover hinge as defined in claim 1, wherein the stop filaments form loops that at least in part project in a perpendicular and/or at an acute angle from a surface of the main textile structure.

5. The airbag cover hinge defined in claim 1, wherein stop filaments are distributed in a regular or irregular manner across the main textile structure.

6. The airbag cover hinge defined in claim 1, further comprising two filler filaments and one stop filament of the main textile structure in a regular or irregular sequence.

7. The airbag cover hinge defined in claim 1, wherein the main textile structure is mobile relative to the stop filaments.

8. The airbag cover hinge defined in claim 1, wherein the stop filaments extend substantially in a direction of a tensile load of the hinge, but in reserve regions for tensile loading are oriented so as to be substantially transverse and/or longitudinal.

9. The airbag cover hinge defined in claim 1, wherein the stop filaments, in order for travel to be implemented, are configured so as to be meandering, zigzag-shaped, loop-shaped, curved, undulated and/or self-covering.

10. The airbag cover hinge defined in claim 1, wherein the main textile structure is embedded in a two-dimensional warp-knitted fabric.

11. The airbag cover hinge defined in claim 1, wherein the stop filaments have relative to one another variable lengths and/or variable tensile strengths.
